(19) United States
(12) Patent Application Publication
(10) Pub. No.: US 2026/0333200 A1
(43) Pub. Date: Oct. 22, 2026

(54) INFORMATION INDICATION METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Jiansheng CAI, Dongguan (CN); Kai WU, Dongguan (CN); Yi WANG, Dongguan (CN); Dongru LI, Dongguan (CN)

(21) Appl. No.: 19/701,811

(22) Filed: Jun. 9, 2026

Related U.S. Application Data
(63) Continuation of application No. PCT/CN2024/137851, filed on Dec. 9, 2024.

(30) Foreign Application Priority Data
Dec. 12, 2023 (CN) 202311711690.7

(51) Int. Cl. H04W 48/10

(52) U.S. Cl. CPC H04W 48/10

(57) ABSTRACT

An information indication method and apparatus, a communication device, and a storage medium are disclosed in the field of communication technologies. The information indication method of embodiments of this application includes: receiving, by a first device, a first channel, where the first channel indicates target information of a second channel or a third channel, the first channel includes at least one of a synchronization channel or a broadcast channel, and the target information includes at least one of frequency domain information, time domain information, or modulation information; and receiving, by the first device, the second channel based on the target information, where the second channel is used for carrying system information of Internet of Things communication.

### CROSS-REFERENCE TO RELATED APPLICATIONS

This application is a bypass continuation application of International Application No. PCT/CN2024/137851, filed on Dec. 9, 2024, which claims the benefit of and priority to Chinese Patent Application No. 202311711690.7, filed with the China National Intellectual Property Administration on Dec. 12, 2023 and entitled “INFORMATION INDICATION METHOD AND APPARATUS, COMMUNICATION DEVICE, AND STORAGE MEDIUM”, the contents of both which being incorporated by reference in their entireties herein.

### TECHNICAL FIELD

This application relates to the field of communication technologies and, in particular, to an information indication method and apparatus, a communication device, and a storage medium.

### BACKGROUND

Ambient Internet of Things (A-IoT) refers to the process of collecting, transmitting, and applying ambient and related information in a fast and accurate form by integrating various possible technical approaches around a specific objective.

### SUMMARY

According to a first aspect, an information indication method is provided, and the method includes:
receiving, by a first device, a first channel, where the first channel indicates target information of a second channel or a third channel, the first channel includes at least one of a synchronization channel or a broadcast channel, and the target information includes at least one of frequency domain information, time domain information, or modulation information; and receiving, by the first device, the second channel based on the target information, where the second channel is used for carrying system information of Internet of Things communication.

According to a second aspect, an information indication method is provided, and the method includes:
sending, by a second device, a first channel, where the first channel indicates target information of a second channel or a third channel, the first channel includes at least one of a synchronization channel or a broadcast channel, and the target information includes at least one of frequency domain information, time domain information, or modulation information; and
sending, by the second device, the second channel based on the target information, where the second channel is used for carrying system information of Internet of Things communication.

According to a third aspect, an information indication apparatus is provided, where the apparatus is applied to a first device, and the apparatus includes:
a first receiving module, configured to receive a first channel, where the first channel indicates target information of a second channel or a third channel, the first channel includes at least one of a synchronization channel or a broadcast channel, and the target information includes at least one of frequency domain information, time domain information, or modulation information; and
a second receiving module, configured to receive the second channel based on the target information, where the second channel is used for carrying system information of Internet of Things communication.

According to a fourth aspect, an information indication apparatus is provided, where the apparatus is applied to a second device, and the apparatus includes:
a first sending module, configured to send a first channel, where the first channel indicates target information of a second channel or a third channel, the first channel includes at least one of a synchronization channel or a broadcast channel, and the target information includes at least one of frequency domain information, time domain information, or modulation information; and
a second sending module, configured to send the second channel based on the target information, where the second channel is used for carrying system information of Internet of Things communication.

According to a fifth aspect, a communication device is provided. The terminal includes a processor and a memory, where the memory stores a program or an instruction that can be run on the processor, and the program or the instruction is executed by the processor to implement the steps of the method according to the first aspect or the second aspect.

According to a sixth aspect, a communication device is provided, including a processor and a communication interface, where
when the communication device is a first device, the communication interface is configured to:
receive a first channel, where the first channel indicates target information of a second channel or a third channel, the first channel includes at least one of a synchronization channel or a broadcast channel, and the target information includes at least one of frequency domain information, time domain information, or modulation information; and
receive the second channel based on the target information, where the second channel is used for carrying system information of Internet of Things communication; and
when the communication device is a second device, the communication interface is configured to:
send a first channel, where the first channel indicates target information of a second channel or a third channel, the first channel includes at least one of a synchronization channel or a broadcast channel, and the target information includes at least one of frequency domain information, time domain information, or modulation information; and
send the second channel based on the target information, where the second channel is used for carrying system information of Internet of Things communication.

According to a seventh aspect, a readable storage medium is provided, where the readable storage medium stores a program or an instruction, and when the program or the instruction is executed by a processor, the steps of the method according to the first aspect or the second aspect are implemented.

According to an eighth aspect, an information indication system is provided, including a first device and a second device. The first device may be configured to perform the steps of the method according to the first aspect, and the second device may be configured to perform the steps of the method according to the second aspect.

According to a ninth aspect, a chip is provided. The chip includes a processor and a communication interface, the communication interface is coupled to the processor, and the processor is configured to run a program or an instruction to implement the method according to the first aspect or the method according to the second aspect.

According to a tenth aspect, a computer program/program product is provided, the computer program/program product is stored in a storage medium, and the program/program product is executed by at least one processor to implement the method according to the first aspect or the method according to the second aspect.

### BRIEF DESCRIPTION OF DRAWINGS

FIG. 1 is a block diagram of a wireless communication system to which embodiments of this application are applicable;

FIG. 2 is a schematic diagram of a generation framework of a multicarrier on-off keying (OOK) signal based on an orthogonal frequency division multiplexing (OFDM) architecture according to an embodiment of this application;

FIG. 3 is a schematic diagram of a sending and spreading sequence of offset quadrature phase shift keying (OQPSK) according to an embodiment of this application;

FIG. 4 is a schematic diagram of a modulation and spreading sequence of differential binary phase shift keying (DBPSK) according to an embodiment of this application;

FIG. 5 is a block diagram of minimum shift keying (MSK) modulation according to an embodiment of this application;

FIG. 6 is a principle diagram of Gaussian filtered minimum shift keying (GMSK) signal modulation according to an embodiment of this application;

FIG. 7 is a flowchart of an information indication method according to an embodiment of this application;

FIG. 8 is a first schematic diagram of a time domain repetition mode according to an embodiment of this application;

FIG. 9 is a second schematic diagram of a time domain repetition mode according to an embodiment of this application;

FIG. 10 is a flowchart of another information indication method according to an embodiment of this application;

FIG. 11 is a structural block diagram of an information indication apparatus according to an embodiment of this application;

FIG. 12 is a structural block diagram of another information indication apparatus according to an embodiment of this application;

FIG. 13 is a structural block diagram of a communication device according to an embodiment of this application;

FIG. 14 is a structural block diagram of a terminal according to an embodiment of this application; and

FIG. 15 is a structural block diagram of a network side device according to an embodiment of this application.

### DETAILED DESCRIPTION

The following clearly describes the technical solutions in the embodiments of this application with reference to the accompanying drawings in the embodiments of this application. Understandably, the described embodiments are some, but not all, of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in this application may be either a direct indication (or referred to as an explicit indication) or an indirect indication (or referred to as an implicit indication). The direct indication may be understood as that a sender clearly informs a receiver of specific information, an operation required to be performed, a request result, or the like in a sent indication; and the indirect indication may be understood as that the receiver determines corresponding information based on an indication sent by the sender, or makes a determination and determines the operation required to be performed, the request result, or the like based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are used in most of the following descriptions, but these technologies can also be applied to a system other than the NR system, for example, a 6th generation (6G) communication system.

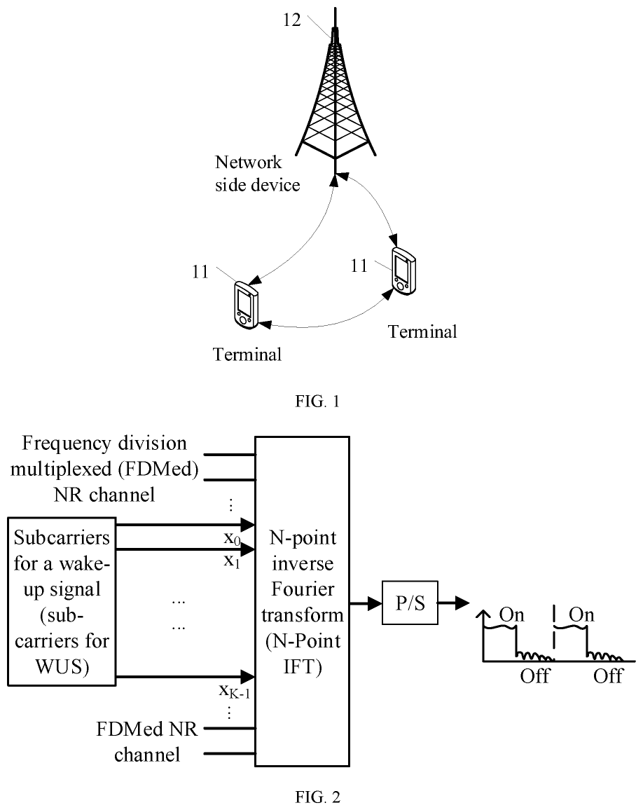

FIG. 1 is a block diagram of a wireless communication system to which the embodiments of this application may be applied. The wireless communication system includes a terminal 11 and a network side device 12.

In some embodiments, the terminal 11 may be an ambient Internet of Things (A-IoT) device, or is referred to as an ambient power (AMP) device, a zero-power device, a low-power IoT device, a response device, a tag, or the like.

The terminal 11 may alternatively be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), ship-borne equipment, pedestrian user equipment (PUE), smart household (household devices with wireless communication functions, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. As long as a same technical effect is achieved, the base station is not limited to a specified technical term. It should be noted that, in the embodiments of this application, only a base station in an NR system is used as an example for description, but a specific type of the base station is not limited.

In the A-IoT, a read-write device, such as a reader, usually needs to communicate with a plurality of ambient Internet of Things devices, such as tag devices (tag). The ambient Internet of Things device may establish a connection with the read-write device, and communicate with the read-write device based on a control instruction of the read-write device. However, currently, the problem of how to establish an initial connection between the ambient Internet of Things device and the reader has not been solved.

For ease of understanding the information processing method according to the embodiments of this application, the following related technologies are described.

### 1. Type and Characteristic of an Ambient Internet of Things (Ambient IoT, A-IoT) Device.

Currently, the ambient Internet of Things device may be characterized based on an energy storage capacity of the ambient Internet of Things device and a capability of generating a radio frequency signal for transmission.

The A-IoT device has one of the following energy storage capabilities:
storage capacity 1: no capability to store energy;
storage capacity 2: energy can be stored up to E1 or E2 joules, where it is possible that E1=E2; and
storage capacity 3: energy can be stored up to E2 joules.

In addition, based on the energy storage capacity of the ambient Internet of Things device and the capability of generating a radio frequency signal for transmission, the Internet of Things device may be classified into the following three types: device A, device B, and device C:
device A: it has no energy storage and no independent signal generation/amplification, namely, backscattering transmission;
device B: it has energy storage and no independent signal generation, that is, backscattering transmission, and use of stored energy may include amplification of a reflected signal; and
device C: it has energy storage and independent signal generation, that is, an active radio frequency component for transmission.

### 2. A-IoT Data or Service Type, Including the Following Two Types:

(1) device-originated (DO) service; and
(2) device-terminated (DT) service.

The device-originated service includes a device-originated autonomous (DO traffic includes DO autonomous, DO-A) service and a device-originated device-terminated triggered (DO device-terminated triggered, DO-DTT) service.

DO data indicates that a data stream originates from an A-IoT device; and DT data indicates that a data stream is transmitted to an A-IoT device.

That a data stream originates from an A-IoT device (that is, DO data) may be further classified into the following two types:
DO-A, that is, the A-IoT device initiates data transmission autonomously, such as connecting to a large quantity of various sensors, and these sensors collect and actively report information about ambiance, device, and biology when necessary; and
DO-DTT, that is, a reader-writer device such as a base station triggers the A-IoT device to initiate data transmission, such as asset identification, and state reporting and tracking, all of which are downlink (DL)-triggered reports, and a reader collects data from a tag by triggering an inventory program. Because the data is generated or initiated in an Internet of Things (IoT) device, the service should be regarded as a DO service initiated by the tag triggered by a control command on a reader side.
   3. A-IoT System Deployment Scenario, which May be Divided into the Following Three Scenarios.

Scenario 1: A-IoT is deployed in a system bandwidth of NR, which is also referred to as in-band deployment. In this scenario, in an implementation, a same base station provides services for an A-IoT device and new radio (NR) UE; and in another implementation, different base stations provide services for an A-IoT device and NR UE.

Scenario 2: A-IoT is deployed in a protection interval of an NR system, which is also referred to as guard band deployment. In this scenario, in an implementation, a same base station provides services for an A-IoT device and NR UE. In another implementation, different base stations provide services for an A-IoT device and NR UE.

Scenario 3: A-IoT is deployed outside a protection interval of an NR system (obviously, it is not in a system bandwidth of NR), which is also referred to as stand-alone deployment. In this scenario, a base station usually provides services only for an A-IoT device.

4. Modulation Mode that May be Used by a Low Power Signal.

### (1) On-Off Keying (OOK)

For the OOK modulation mode, there are two generation modes: one is a multicarrier OOK signal (MC-OOK) based on an orthogonal frequency division multiplexing (OFDM) architecture; and the other is a single carrier OOK signal.

For the multicarrier OOK signal generated based on the OFDM architecture, a design idea is not to change an originating architecture of the existing base station, so proper data is sent on an OFDM subcarrier to make it appear as a square wave signal in time domain, and a generation framework is shown in FIG. 2. Modes for generating the multicarrier OOK signal generated based on the OFDM architecture include the following types.

### Mode 1: OOK-1

In OOK-1, mainly one OFDM symbol carries one piece of bit information. When bit1 is transmitted, data is transmitted in frequency domain of a corresponding symbol, and when bit0 is transmitted, data is not transmitted in frequency domain of a corresponding symbol. A subcarrier spacing needs to be increased to improve a transmission rate. The data in frequency domain may be a ZC (namely, Zadoff-Chu) sequence, a quadrature amplitude modulation (QAM) signal, or the like to ensure flatness of a frequency domain signal. It is assumed that power pooling between symbols is not performed, data is not transmitted on OFDM without bit transmission, and there may be a certain power loss.

### Mode 2: OOK-2

The OOK-2 waveform is similar to a frequency shift keying (FSK) waveform, mainly in that a plurality of frequency bands (segment) are divided in frequency domain, where each segment carries one bit. When bit1 is transmitted, data is transmitted on a corresponding segment, and when bit0 is transmitted, data is not transmitted on a corresponding segment. The data in frequency domain may be a ZC sequence, a QAM signal, or the like to ensure flatness of a frequency domain signal. It is assumed that power pooling within symbols is not performed, data is not transmitted on a segment without bit transmission, and there may be a certain power loss.

### Mode 3: OOK-3

In OOK-3, a plurality of segments are divided in frequency domain, then some subcarriers (tone) on each segment may be modulated, and a receive end takes out corresponding tones through a Goertzel receiver and demodulates them.

### Mode 4: OOK-4

The OOK-4 waveform is a more flexible type among several waveforms, and can control a transmission rate by adjusting a quantity of bits transmitted within one OFDM symbol. There are two modes for generating OOK-4: one is generating through discrete Fourier transform spreading orthogonal frequency division multiplexing (DFT-S-FDM), and the other is generating through least square (LS).

An idea of DFT-S-OFDM is to generate a desired waveform in time domain, where a quantity of sampling points of the waveform in time domain is equal to a quantity of resource elements (RE) of a wake-up signal (WUS) bandwidth, and obtain frequency domain information through discrete Fourier transform (DFT).

An idea of leastsquare is to deduce a frequency domain waveform by using a desired time domain waveform, which mainly optimizes an input frequency domain sequence X by using a fast Fourier transform (FFT) matrix and an ideal time domain waveform.

### (2) Offset Quadrature Phase Shift Keying (OQPSK) or Differential Binary Phase Shift Keying (DBPSK)

An active tag may use OQPSK modulation or DBPSK modulation to send data. These two modulation modes belong to constant envelope modulation technology, and the following is a brief introduction of the two modulation modes.

An OQPSK modulation process may be described as follows: a serially input binary data code stream is split into two different paths, an I-path and a Q-path, for transmission, where “I” is a component used for synchronizing with a data waveform, and Q is a part “orthogonal to” the data waveform, that is, an even bit of original input data is allocated to the I-path, an odd bit is allocated to the Q-path, and it is ensured that code streams of in-phase and quadrature branches are staggered in time by half a symbol period. Then, I-channel data and Q-channel data are respectively used to modulate a carrier, that is, one of four discrete phase changes is used for representing a symbol to be transmitted (that is, a bit pair).

Similar to QPSK, BPSK uses a phase to carry symbol information. For example, when an input symbol is “1”, an output of a baseband modulator is 1 (the phase is 0 degrees); and when an input symbol is “0”, an output of the baseband modulator is −1 (the phase is 0 degrees). However, there is a problem of phase ambiguity in BPSK. The phase ambiguity indicates that a recovered digital information may change from “0” to “1” or from “1” to “0”, resulting in wrong recovery. This phenomenon of error recovery in a receiving system because a local reference carrier is inverted is referred to as a “phase ambiguity” phenomenon. To solve this problem, differential coding is introduced, so that decoding at the receiving end is determined based on a change of phase, rather than an absolute value of phase, which is DBPSK.

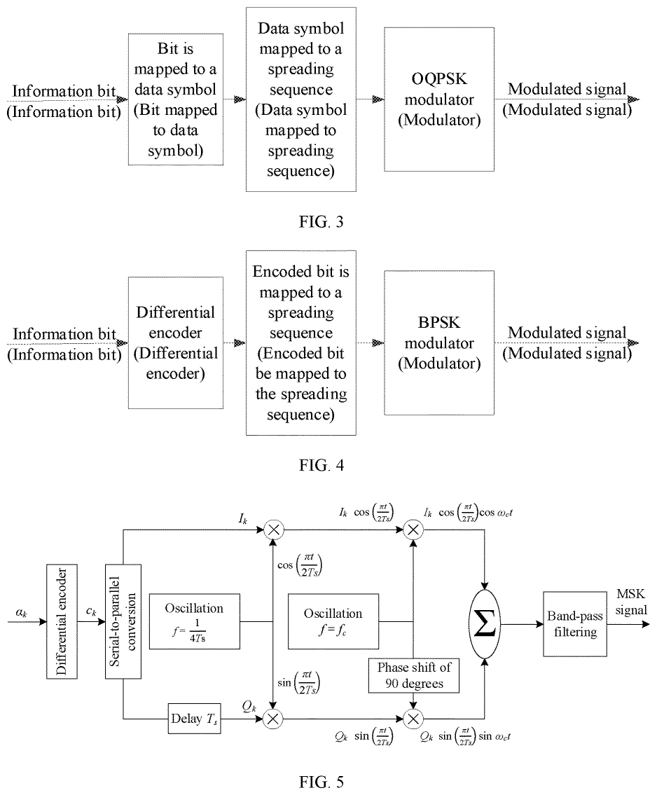

To obtain better link performance and anti-interference performance, original bit information may be expanded by using at least one of the following manners: spreading a sequence or coding. A common processing manner is shown in FIG. 3 or FIG. 4.

### (3) Minimum Shift Keying (MSK) and Gaussian Filtered Minimum Shift Keying (GMSK) Modulation

The MSK is a constant envelope continuous phase modulation, and its modulation mode is developed from binary frequency shift keying (FSK) modulation. In the FSK, a carrier frequency changes with a random change of a modulated signal, the modulated signal is usually “0” or “1”, and a modulated phase is discontinuous. If the phase is continuous, it is referred to as continuous phase frequency shift keying (CP-FSK). The MSK modulation mode is a special form of CP-FSK with a modulation index of 0.5. An MSK modulation principle is as follows:

$${S}_{MSK} ( t ) = cos [ {ω}_{c} t + \frac{π {a}_{k}}{2 {T}_{s}} + {ϕ}_{k} ] .$$

Let

$${θ}_{k} ( t ) = \frac{π {a}_{k}}{2 {T}_{s}} + {ϕ}_{k} ,$$

where up is referred to as an additional phase function, used for ensuring phase continuity between different symbols, ω_{c}t is a carrier angular frequency, Tₛ is a symbol width; and aₖ is a phase constant of a k^{th} symbol. An MSK modulation block diagram is shown in FIG. 5.

Because a phase line of MSK is a curve, and it is observed from a spectrum analyzer that a sidelobe of its power spectrum is shifted from a central frequency, an attenuation is slow. Therefore, a Gaussian filter is added before MSK modulation to make up for shortcomings of MSK, to improve attenuation performance, and therefore, the modulator is referred to as GMSK.

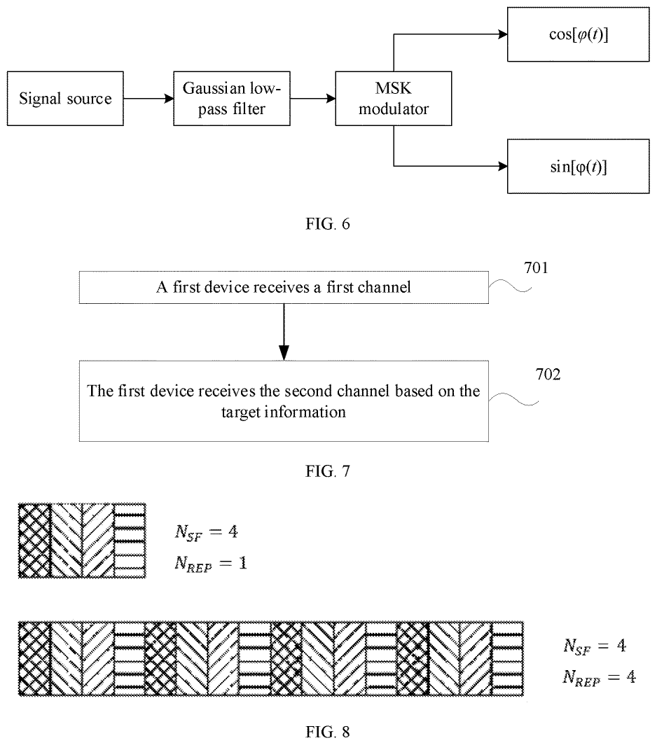

It can be seen from FIG. 6 that, GMSK modulation is to add a Gaussian low-pass filter in front of an MSK modulator, to make the signal smoother and improve sidelobe attenuation performance of the power spectrum obviously. After MSK modulation, symbol data, namely, the I-path and the Q-path, are output, and finally a GMSK expression is obtained as follows:

S_{GMSK}(t)=A cos[ω_{c}t+φ(t,a)]=A[cos φ(t,a)cos ω_{c}t−sin φ(t,a)sin ω_{c}t]

A represents a signal envelope, ω_{c} represents a carrier angular frequency, and φ(t,a) represents an information phase.

Embodiments of this application provide an information indication method and apparatus, a communication device, and a storage medium, to solve the problem of how to establish an initial connection between an ambient Internet of Things device and a reader-writer device.

The following describes in detail the information indication method provided in the embodiments of this application through some embodiments and application scenarios thereof with reference to the accompanying drawings.

An embodiment of this application provides an information indication method. As shown in FIG. 7, the method may include the following step 701 to step 702.

Step 701: A first device receives a first channel.

The first device may be a terminal device, such as an Internet of Things device (for example, tag), and the Internet of Things device may include an ultra-low complexity and ultra-low power consumption terminal.

The first channel indicates target information of a second channel or a third channel, the first channel includes at least one of a synchronization channel (for example, a low power synchronization signal block (LP-SSB)) or a broadcast channel, and the target information includes at least one of frequency domain information, time domain information, or modulation information.

That is, the first channel indicates at least one of frequency domain information, time domain information, or modulation information of the second channel, or the first channel indicates at least one of frequency domain information, time domain information, or modulation information of the third channel.

In addition, the third channel indicates the second channel.

Optionally, the second channel includes a downlink shared channel, such as a physical downlink shared channel (PDSCH).

Optionally, the third channel includes a downlink control channel, such as a physical downlink control channel (PDCCH).

For example, at least one of the synchronization channel or the broadcast channel may indicate at least one of frequency domain information, time domain information, and modulation information of the PDCCH, or indicate at least one of frequency domain information, time domain information, or modulation information of the PDSCH.

In addition, system information may generally be divided into a master information block (MIB), system information block type 1 (SIB1), and other system information block types (other-SIB). The MIB may be carried by a low power synchronization signal block (LP-SSB), and SIB1 may be carried by a downlink shared channel (such as a PDSCH). That is, the system information carried by the second channel may include SIB1.

Step 702: The first device receives the second channel based on the target information.

The second channel is used for carrying system information of Internet of Things communication; and the system information may include SIB1.

In this embodiment of this application, the first channel received by the first device indicates at least one of frequency domain information, time domain information, or modulation information of the second channel, or the first channel indicates at least one of frequency domain information, time domain information, or modulation information of the third channel. Therefore, the first device may receive the second channel based on at least one of frequency domain information, time domain information, or modulation information of the second channel; or receive the third channel based on at least one of frequency domain information, time domain information, or modulation information of the third channel, thereby receiving the second channel based on an indication of the third channel. The second channel carries the system information of Internet of Things communication. Therefore, after receiving the second channel, the first device may obtain the system information of Internet of Things communication, to facilitate an initial access or other actions of the first device.

It can be learned from the above step 701 to step 702 that in this embodiment of this application, the target information of the second channel or the target information of the third channel may be indicated by at least one of the synchronization channel or the broadcast channel, so that after receiving the first channel, the first device may receive, based on the target information of the second channel, the second channel carrying the system information of Internet of Things communication; or receive the third channel based on the target information of the third channel, and further receive, based on the indication of the third channel, the second channel carrying the system information of Internet of Things communication. That is, in this embodiment of this application, at least one of the synchronization channel or the broadcast channel may directly indicate the second channel carrying the system information of Internet of Things communication, or indirectly indicate the second channel carrying the system information of Internet of Things communication, so that the first device may obtain the system information of Internet of Things communication. Therefore, in this embodiment of this application, necessary system information required in an initial access of the Internet of Things device is provided, and the problem of how to establish an initial connection between an ambient Internet of Things device and a reader-writer device is solved.

Optionally, the receiving, by the first device, the second channel based on the target information includes one of the following A-1 to A-3.

A-1: In a case that the first channel indicates the target information of the third channel, the first device receives the third channel by using the target information of the third channel, and receives the second channel by using the target information of the second channel indicated by the third channel.

It can be learned from A-1 that, the first channel may indirectly indicate the second channel, that is, the first channel may indicate the target information of the third channel, and the third channel may indicate the target information of the second channel; and that is, the first channel indicates at least one of frequency domain information, time domain information, or modulation information of the third channel, and the third channel indicates at least one of frequency domain information, time domain information, or modulation information of the second channel. For example, when the first channel is a synchronization or broadcast channel, the second channel is a PDSCH, and the third channel is a PDSCH, the synchronization or broadcast channel may indicate the PDCCH, and the PDCCH (for example, downlink control information (DCI) of the PDCCH) indicates the PDSCH.

In this case, after receiving the first channel, the first device may receive the third channel based on at least one of frequency domain information, time domain information, or modulation information that are of the third channel and that are indicated by the first channel, and further receive, after receiving the third channel, the second channel based on at least one of frequency domain information, time domain information, or modulation information that are of the second channel and that are indicated by the third channel, thereby obtaining the system information of Internet of Things communication from the received second channel, to facilitate an initial access or other actions of the first device.

A-2: The first device receives, in a case that the first channel indicates first information, the second channel by using the first information and second information indicated by header information of the second channel, where the first information includes a part of the target information of the second channel, and the second information includes information other than the first information in the target information of the second channel.

It can be learned from A-2 that, the first channel and the header information of the second channel may jointly indicate the second channel, that is, information of at least one of frequency domain information, time domain information, or modulation information of the second channel may be divided into two parts, that is, the first information and the second information, so that the first channel indicates the first information, and the header information of the second channel indicates the second information. For example, when the first channel is a synchronization or broadcast channel, and the second channel is a PDSCH, the synchronization or broadcast channel and the header information of the PDSCH may jointly indicate the PDSCH.

In this case, the first device may receive the second channel based on the first information indicated by the first channel and the second information indicated by the header information of the second channel, thereby obtaining the system information of Internet of Things communication from the received second channel, to facilitate an initial access or other actions of the first device.

It should be noted that for the PDSCH, to reduce resource overheads and perform more flexible scheduling, the first channel may not directly indicate all its messages. For example, only the PDSCH or a part of modulation information of the PDSCH (header) may be indicated, such as a waveform and a coding mode, and then the PDSCH (header) further indicates the PDSCH (payload), so that this part of overhead may be omitted in a subsequent DCI indication.

In addition, for the PDCCH, some of its modulation parameters may be fixed. For example, Manchester coding is used for coding, and a payload size of transmission is fixed, while remaining modulation parameters may be determined by using an indication of the first channel (for example, information such as a code rate is determined by using duration of a monitoring window, a waveform, and a quantity of repetition transmissions).

The header information of the second channel belongs to a part of the second channel, that is, the header information of the second channel may indicate a part of the target information of the second channel (information such as a modulation and coding parameter, a payload size, and a time domain length of the second channel), and a payload part of the second channel is used for carrying the system information of Internet of Things communication (such as SIB1).

In addition, optionally, in a case that the first channel indicates the first information, and the header information of the second channel indicates the second information, the first channel further indicates the header information of the second channel. That is, the header information of the second channel may be indicated by the first channel.

In addition, when the second channel is a PDSCH, the header information (header) of the PDSCH may be a specific byte or a specific sequence in a PDSCH in a physical layer, or may satisfy one of the following B-1 to B-4.

B-1: Related information carried by the PDSCH header for indicating SIB1 is from a subheader of a medium access control (MAC) SDU. For example, when a MAC subPDU (that is, a subPDU) is defined, including one MAC subheader and one MAC SDU, the MAC subheader indicates control information of SIB1, and the MAC SDU indicates SIB1 (that is, SIB1 carried by the PDSCH is from the MAC SDU).

B-2: Related information carried by the PDSCH header for indicating SIB1 is from a MAC CE. For example, when a MAC PDU is defined, including a first object and a second object, where the first object includes a MAC subheader and a MAC CE, and the second object includes a MAC subheader and a MAC SDU, the first object indicates SIB1 control information, and the second object indicates SIB1 (that is, SIB1 carried by the PDSCH is from the first object).

B-3: Related information carried by the PDSCH header for indicating SIB1 is from a MAC subPDU of a MAC file including only header information (MAC header only). For example, a MAC PDU is defined, including a MAC file including only header information (MAC subheader only) and a third object. When the third object includes the MAC subheader and the MAC SDU, the MAC subheader only indicates SIB1 control information, and the third object indicates SIB1 (that is, SIB1 carried by the PDSCH is from the third object).

B-4: The PDSCH header conforms to a MAC CE form of a design layer, such as defining a MAC subheader and a MAC CE, to indicate SIB1 control information and SIB1 respectively (that is, related information carried by the PDSCH header for indicating SIB1 is from the MAC subheader, and SIB1 carried by the PDSCH is from the MAC SDU).

It should be noted that a data entity coming from or going to a higher protocol layer is referred to as a service data unit (SDU), and a data entity coming from or going to a lower protocol layer is referred to as a protocol data unit (PDU).

A-3: The first device receives, in a case that the first channel indicates the target information of the second channel, the second channel by using the target information of the second channel.

It can be learned from A-3 that, the first channel may directly indicate the second channel, that is, the first channel may directly indicate at least one of frequency domain information, time domain information, or modulation information of the second channel. For example, when the first channel is a synchronization or broadcast channel, and the second channel is a PDSCH, the synchronization or broadcast channel may directly indicate the PDSCH.

In this case, after receiving the first channel, the first device may receive the second channel based on at least one of frequency domain information, time domain information, or modulation information that are of the second channel and that are indicated by the first channel, thereby obtaining the system information of Internet of Things communication from the received second channel, to facilitate an initial access or other actions of the first device.

Optionally, in a case that the target object indicates the third information, the following O-1 is satisfied.

O-1: The target object carries target indication information, and the target indication information indicates a value of the third information in a target table.

The target table is a table in a target correspondence that corresponds to at least one of a device type, a power level, a service type of the first device, or a deployment mode of an ambient Internet of Things that the first device is to access, and the target correspondence includes a correspondence between the device type, the power level, the service type, the deployment mode of the ambient Internet of Things, and a table including the value of the third information;
in a case that the target object includes the first channel, the third information includes the target information of the third channel, or includes the first information;
in a case that the target object includes the third channel, the third information includes the target information of the second channel; and
in a case that the target object includes the header information of the second channel, the third information includes the second information.

It can be learned from the above A-1 to A-3 that:
the first channel may indicate the target information of the third channel, or the first information, or the target information of the second channel;
the third channel may indicate the target information of the second channel; and
the header information of the second channel may indicate the second information.

When a channel indicates information, it can be applied to a case in which a value of information in a corresponding table is indicated by using indication information.

For example, when the first channel indicates the target information of the third channel, the first channel carries first indication information, the first indication information indicates a value of the target information of the third channel in a first table, the first table is a table in a first correspondence that corresponds to at least one of a device type, a power level, a service type, or a deployment mode of the first device, and the first correspondence includes a correspondence between the device type, the power level, the service type, the deployment mode, and a table including the value of the target information of the third channel.

For example, when frequency domain information of the third channel is stored in a table, and tables corresponding to different device types (capabilities), power levels, service types, and deployment modes of the ambient Internet of Things are different, a table corresponding to a device type, a power level, a service type of the first device, and a deployment mode of an ambient Internet of Things to access may be determined, and then the synchronization or broadcast channel may indicate which values in the table are used for frequency domain information, for example, may indicate an index of a corresponding value in the table.

It should be noted that in a table, a parameter in frequency domain information may have at least one value.

Alternatively, for example, when the third channel indicates the target information of the second channel, the third channel carries second indication information, the second indication information indicates a value of the target information of the second channel in a second table, the second table is a table in a second correspondence that corresponds to at least one of a device type, a power level, a service type, or a deployment mode of the first device, and the second correspondence includes a correspondence between the device type, the power level, the service type, the deployment mode, and a table including the value of the target information of the second channel.

Alternatively, for example, when the first channel indicates the first information, the first channel carries third indication information, the third indication information indicates a value of the first information in a second table, the third table is a table in a third correspondence that corresponds to at least one of a device type, a power level, a service type, or a deployment mode of the first device, and the third correspondence includes a correspondence between the device type, the power level, the service type, the deployment mode, and a table including the value of the first information.

Alternatively, for example, when the header information of the second channel indicates the second information, the header information of the second channel carries fourth indication information, the fourth indication information indicates a value of the second information in a fourth table, the fourth table is a table in a fourth correspondence that corresponds to at least one of a device type, a power level, a service type, or a deployment mode of the first device, and the fourth correspondence includes a correspondence between the device type, the power level, the service type, the deployment mode, and a table including the value of the second information.

Alternatively, for example, when the first channel indicates the target information of the second channel, the first channel carries fifth indication information, the fifth indication information indicates a value of the target information of the second channel in a fifth table, the fifth table is a table in a fifth correspondence that corresponds to at least one of a device type, a power level, a service type, or a deployment mode of the first device, and the fifth correspondence includes a correspondence between the device type, the power level, the service type, the deployment mode, and a table including the value of the target information of the second channel.

Optionally, the target indication information satisfies at least one of the following C-1 to C-3.

C-1: At least a part of the target indication information is indicated by using a specific byte or a specific sequence of the target object.

C-2: At least a part of the target indication information is determined based on a length of CRC. That is, a correspondence between different values of the at least a part of the target indication information and a CRC length of the target object may be determined in advance, and then the values of the at least a part of the target indication information may be determined based on an actual CRC length of the target object.

For example, when the target object indicates the third information, the target object includes the first channel, and the third information includes the target information of the third channel (that is, the first channel indicates the target information of the third channel), if the first channel includes indication information of a quantity of frequency bands occupied in frequency domain of the third channel, based on a correspondence between the quantity of frequency bands occupied in frequency domain of the third channel and the CRC length of the first channel, for example, a quantity of frequency bands corresponding to a first length is x1, and a quantity of frequency bands corresponding to a second length is x2, if an actual CRC length of the first channel is the first length, the first channel includes indication information that the quantity of frequency bands occupied in frequency domain of the third channel is x1.

C-3: At least a part of the target indication information is determined based on a scrambling mode of CRC. That is, a correspondence between different values of the at least a part of the target indication information and a scrambling mode of CRC of the target object may be determined in advance, and then the values of the at least a part of the target indication information may be determined based on an actual CRC scrambling mode of the target object.

For example, when the target object indicates the third information, the target object includes the first channel, and the third information includes the target information of the third channel (that is, the first channel indicates the target information of the third channel), if the first channel includes indication information of a quantity of frequency bands occupied in frequency domain of the third channel, based on a correspondence between the quantity of frequency bands occupied in frequency domain of the third channel and a CRC scrambling mode of the first channel, for example, a quantity of frequency bands corresponding to a first CRC scrambling mode is x1, and a quantity of frequency bands corresponding to a second CRC scrambling mode is x2, if an actual CRC scrambling mode of the first channel is the first CRC scrambling mode, the first channel includes indication information that the quantity of frequency bands occupied in frequency domain of the third channel is x1.

Therefore, the at least a part of the target indication information may be indicated by a specific byte or a specific sequence of the target object, or may be carried through CRC.

It should be noted that the target indication information may be indicated by a specific byte or a specific sequence of the target object alone, or determined based on the length of CRC alone, or determined based on the scrambling mode of CRC alone. It is also possible to divide the target indication information into at least two parts, where different parts respectively satisfy one of the above C-1 to C-3.

For example, when the target object indicates the third information, the target object includes the first channel, and the third information includes the target information of the third channel (that is, the first channel indicates the target information of the third channel), if the first channel includes indication information of a quantity of frequency bands occupied in frequency domain of the third channel, and the indication information includes 16 bits, where a correspondence between upper eight bits and the CRC scrambling mode of the first channel and a correspondence between lower eight bits and the CRC length of the first channel may be determined in advance, upper eight bits corresponding to an actual CRC scrambling mode of the first channel and lower eight bits corresponding to an actual CRC length of the first channel jointly indicate the quantity of frequency bands occupied in frequency domain of the third channel.

Optionally, frequency domain information of at least one of the second channel or the third channel includes at least one of the following D-1 to D-4:
D-1: a frequency domain start point position (for example, a carrier, a bandwidth part (BWP), or a position of a frequency band in which the second channel or the third channel is located);
D-2: a quantity of frequency bands occupied in frequency domain;
D-3: a bandwidth size of a signal; and
D-4: a multiplexing mode with the first channel.

It should be noted that:
the frequency domain information of the third channel indicated by the first channel may include at least one of the above D-1 to D-4;
the frequency domain information of the second channel indicated by the third channel may include at least one of the above D-1 to D-4;
if the first information indicated by the first channel includes frequency domain information, at least one of the above D-1 to D-4 may also be included;
if the second information indicated by the header information of the second channel includes frequency domain information, at least one of the above D-1 to D-4 may also be included; and
the frequency domain information of the second channel indicated by the first channel may include at least one of the above D-1 to D-4.

That is, the frequency domain information of the second channel (for example, a PDSCH) may include at least one of the above D-1 to D-4, and the frequency domain information of the third channel (for example, a PDCCH) may include at least one of the above D-1 to D-4.

For the above D-1, the frequency domain start point position of the second channel or the third channel may be determined by performing a frequency domain offset on the frequency domain position of the first channel (for example, an LP-SSB). For example, the frequency domain start point position of the second channel or the third channel is: a start point offset x*freq_space of the LP-SSB, where x is an integer, indicated by MIB, and freq_space represents a predefined interval, for example, an operating bandwidth of an A-IoT device, or a frequency band interval (such as 1 RB) divided by the network for an A-IoT system, or a subcarrier spacing and a raster interval of the A-IoT system, or a carrier bandwidth of the A-IoT system, or a BWP bandwidth of the A-IoT system.

In addition, a frequency domain offset of the second channel relative to the LP-SSB is described as follows.

Case 1: The LP-SSB and the second channel are on a carrier, a BWP, or a narrow band. In this case, the frequency domain offset is similar to a raster offset (rasterOffset), and helps to correct a frequency offset error. The first device may determine a position of the second channel based on the frequency domain offset.

Case 2: The LP-SSB and the second channel are not on a carrier, a BWP, or a narrow band. In this case, it is necessary to indicate not only a frequency domain offset in the carrier/BWP/narrow band, but also another offset, to represent an offset of the carrier/BWP/narrow band index. The first device determines the position of the second channel based on these two indications.

Carriers/BWPs/segments with adjacent indexes may be adjacent or non-adjacent in frequency domain, but specifically, a position of each index does not need the MIB to indicate, and may be predefined (for example, if the ambient Internet of Things is in an in-band deployment mode, only a physical resource block (PRB) that satisfies conditions can be allowed as the carrier of A-IoT).

Similarly, the frequency domain offset of the third channel relative to the LP-SSB is also applicable to the above case 1 and case 2.

In addition, whether the LP-SSB and the second channel are on a same candidate carrier/BWP/narrow band and whether the LP-SSB and the third channel are on a same candidate carrier/BWP/narrow band may be related to the deployment mode of the ambient Internet of Things. For example, for in-band deployment, the LP-SSB and the second/third channel may be in a same BWP; and for stand-alone deployment, it may be required to further indicate a relationship.

For the above D-2, when the quantity of frequency bands (or referred to as a quantity of segments) occupied in frequency domain of the second channel or the third channel is greater than or equal to 2, a receiver of the first device is required to have a capability of simultaneously receiving a plurality of segments and demodulating them, thereby enhancing coverage performance.

If the quantity of frequency bands occupied in frequency domain of the second channel or the third channel (that is, the quantity of segments) is greater than or equal to 2, a corresponding position may be specified in a protocol or indicated by the network side device. For example, when the quantity of segments is even, positions of segments may be center-aligned, and the frequency domain start point position in the above D-1 is a center point. It can be understood that the positions of the segments may be start-aligned in addition to being center-aligned. In this case, the frequency domain start point position in the above D-1 is a start point.

In addition, a position of each segment may be determined based on an offset relative to the start point (that is, the frequency domain start point position). For example, a 1^{st} segment is offset by y BW_{device} from the start point, and a 2^{nd} segment is offset by z BW_{device} from the start point; BW_{device} represents an operating bandwidth of the first device, and may alternatively be another frequency domain interval; or a position and an index of each segment may be pre-configured by the network or specified in the protocol.

In addition, multi-band parallel reception may be related to a device type (capability), a power level, a deployment mode of ambient Internet of Things, and other manners, as described in the following E-1 to E-2.

E-1: From a perspective of device type, for example, the above device Cis an active tag, its power consumption is high, and a receiver architecture may have a plurality of filters to simultaneously receive signals in a plurality of frequency bands, thereby improving coverage performance. For the above device A, because its main application scenario is indoor and its power consumption is low, a requirement for coverage performance is lower, and a capability of simultaneously receiving a plurality of frequency bands is not needed.

E-2: From a perspective of deployment mode of ambient Internet of Things, bandwidth resources of guard band deployment are limited, the PDCCH may not have many bandwidth resources, with a small quantity of frequency bands, while stand-alone deployment has the most bandwidth resources, with a large quantity of available frequency bands or segments.

For the above D-3, a bandwidth size of a signal of the second channel or the third channel (that is, a bandwidth magnitude of the signal) mainly affects the coverage performance, and also related to the device type (capability), the power level, the deployment mode of the ambient Internet of Things, and other manners. An effect is similar to that described in “the above E-1 to E-2”.

For the above D-4, a multiplexing mode of the second channel or the third channel relative to the first channel (for example, the LP-SSB) can be mainly divided into two types: TDM and FDM, and the multiplexing mode may be related to the deployment scenario. For example, for bandwidth-limited deployment and guard band deployment, TDM is used preferentially; and for a receiver that does not have the capability of simultaneously receiving a plurality of frequency bands (such as device A or device B described above), TDM is also used preferentially.

Optionally, time domain information of at least one of the second channel or the third channel includes at least one of the following F-1 to F-4:
F-1: time domain position information;
F-2: a size of a monitoring window;
F-3: a monitoring cycle (the monitoring cycle may be related to a service of A-IoT, and monitoring cycles of the second channel and the third channel are also different); and
F-4: a time domain interleaving mode.

It should be noted that:
the time domain information of the third channel indicated by the first channel may include at least one of the above F-1 to F-4;
the time domain information of the second channel indicated by the third channel may include at least one of the above F-1 to F-4;
if the first information indicated by the first channel includes time domain information, at least one of the above F-1 to F-4 may also be included;
if the second information indicated by the header information of the second channel includes time domain information, at least one of the above F-1 to F-4 may also be included; and
the time domain information of the second channel indicated by the first channel may include at least one of the above F-1 to F-4.

That is, the time domain information of the second channel (for example, a PDSCH) may include at least one of the above F-1 to F-4, and the time domain information of the third channel (for example, a PDCCH) may include at least one of the above F-1 to F-4.

For the above F-1, optionally, time domain position information of at least one of the second channel or the third channel includes at least one of the following:
a time domain position of a monitoring window of a channel to which the time domain position information belongs;
a start point of a monitoring cycle of a channel to which the time domain position information belongs; and
an offset of a monitoring window of a channel to which the time domain position information belongs relative to a start point of a monitoring cycle.

Therefore, when there is no monitoring cycle in the second channel, the time domain position information of the second channel may include a time domain position of the monitoring window of the second channel, that is, in this case, a time domain start point of the second channel may be indicated by the time domain position of the monitoring window of the second channel.

Similarly, when there is no monitoring cycle in the third channel, the time domain position information of the third channel may include a time domain position of the monitoring window of the third channel, that is, in this case, a time domain start point of the third channel may be indicated by the time domain position of the monitoring window of the third channel.

In addition, because bits of MIB in the A-IoT system are limited, to reduce overheads, it may be assumed that a monitoring cycle M of an occasion in a slot or a time unit is fixed, or is bound with other parameters, or is predefined in the protocol. Then, after the position of the monitoring cycle is learned, an offset of the monitoring window relative to the monitoring cycle further needs to be determined through indication, to determine the time domain position of the second channel or the third channel.

Therefore, when there is a monitoring cycle in the second channel, the time domain position of the second channel may be determined by using a start point of the monitoring cycle of the second channel and an offset of the monitoring window relative to the start point of the monitoring cycle. Similarly, when there is a monitoring cycle in the third channel, the time domain position of the third channel may be determined by using a start point of the monitoring cycle of the third channel and an offset of the monitoring window relative to the start point of the monitoring cycle.

It should be noted that the offset of the monitoring window relative to the start point of the monitoring cycle may refer to an offset in a slot, or an offset in a symbol, or an offset in other time units.

In addition, a correspondence between an SSB index and an offset set may be determined in advance, so that a corresponding offset set may be determined based on the current SSB, to indicate which value in the set is used as the offset of the monitoring window relative to the start point of the monitoring cycle.

For the above F-2, optionally, a size of a monitoring window of at least one of the second channel or the third channel is represented by using one of the following:
a time domain length occupied by a channel to which the monitoring window belongs;
a time domain length occupied by one transport block of the system information; and
a time domain length occupied by the header information of the second channel.

Therefore, the size of the monitoring window of the second channel may be: a time domain length of the second channel (that is, a time length occupied by the second channel in time domain), or a length occupied by one TB of SIB1, or a time domain length occupied by the header information of the second channel; and the size of the monitoring window of the third channel may be: a time domain length of the third channel (that is, a time length occupied by the third channel in time domain).

For the above F-4: the time domain interleaving mode refers to an interleaving mode and a non-interleaving mode, such as a width, a depth, and other related parameters of interleaving.

Optionally, modulation information of at least one of the second channel or the third channel includes at least one of the following G-1 to G-6:
G-1: a payload size (payload);
G-2: a modulation parameter;
G-3: a waveform parameter;
G-4: a quantity of time domain repetitions;
G-5: a time domain repetition mode; and
G-6: channel structure information.

It should be noted that:
the modulation information of the third channel indicated by the first channel may include at least one of the above G-1 to G-6;
the modulation information of the second channel indicated by the third channel may include at least one of the above G-1 to G-6;
if the first information indicated by the first channel includes modulation information, at least one of the above G-1 to G-6 may also be included;
if the second information indicated by the header information of the second channel includes modulation information, at least one of the above G-1 to G-6 may also be included; and
the modulation information of the second channel indicated by the first channel may include at least one of the above G-1 to G-6.

That is, the modulation information of the second channel (for example, a PDSCH) may include at least one of the above G-1 to G-6, and the modulation information of the third channel (for example, a PDCCH) may include at least one of the above G-1 to G-6.

For the above G-2, optionally, the modulation parameter includes one of the following:
a parameter of linear coding, such as a linear coding method and a corresponding code rate (such as Miller coding, FMO coding, Manchester coding, a spreading sequence, and corresponding code rates thereof); and
a parameter of channel coding, such as a channel coding method and a corresponding code rate (error-correcting coding such as convolutional code, low density parity check code (LDPC), polar code, Hamming code, Reed-muller code, and code rates thereof).

For the above G-3, optionally, the waveform parameter includes at least one of the following modulation modes:
Gaussian filtered minimum shift keying (GMSK);
on-off keying (OOK);
amplitude shift keying (ASK);
frequency shift keying (FSK);
differential binary phase shift keying (DBPSK);
offset quadrature phase shift keying (OQPSK);
phase reverse amplitude shift keying (PR-ASK);
double sideband amplitude shift keying (DSB-ASK);
single sideband amplitude shift keying (SSB-ASK);
OOK-1;
OOK-2; or
OOK-4, where
OOK-1, OOK-2, and OOK-4 represent different multicarrier OOK signal generation modes based on an orthogonal frequency division multiplexing (OFDM) architecture.

For G-4 and G-5: similar to the aforementioned “quantity of frequency bands occupied in frequency domain”, the coverage performance is enhanced through retransmission. The time domain repetition mode may be classified into the following two types.

Type 1: Send a complete signal repeatedly, as shown in FIG. 8.

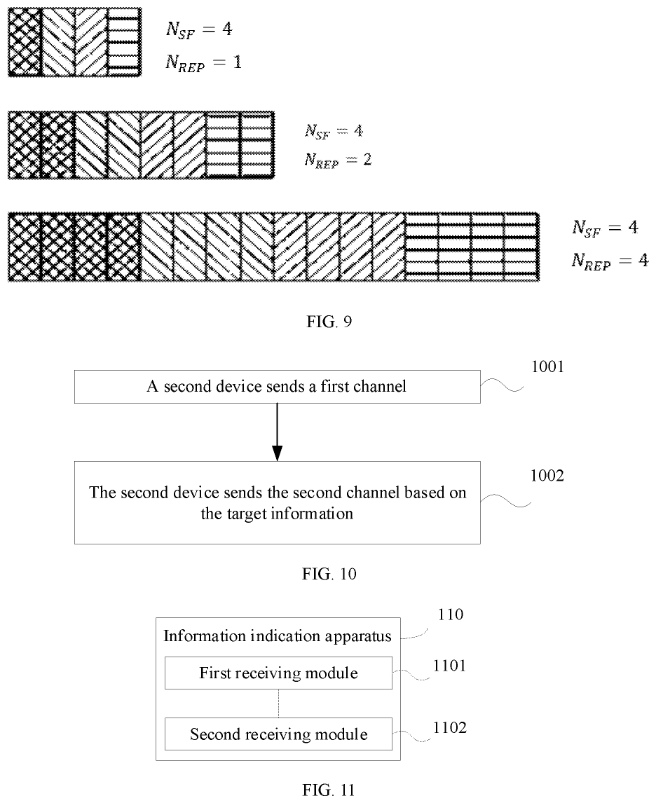

Type 2: Send each bit repeatedly, as shown in FIG. 9.

In FIG. 8 and FIG. 9, N_{SF} represents a quantity of bits included in a complete signal; and N_{REP} represents a quantity of time domain repetitions.

In addition, it should be noted that if better coverage is needed, the quantity of retransmissions (namely, the quantity of time domain repetitions) may be set to be large, and when the power level is low, the quantity of retransmissions may alternatively be increased to ensure the coverage performance; and for in-band deployment of TDM, it is sometimes necessary to stagger with a non-A-IoT service in time domain, and for stand-alone deployment, it is more flexible in time domain.

It can be learned from G-6 that, in the first channel, a channel structure of the second channel or the third channel may further be indicated, such as whether there is a preamble, whether there is a code field, whether there is a header, a transmission pattern, or the like.

The preamble signal is used for timing synchronization to correct a time offset or channel estimation;
the code field is used for determining a payload of control information or a modulation and coding scheme (MCS);
the header is a possible structure of the PDSCH or the PDCCH, and indicates a related modulation and coding parameter and a payload size of a subsequent payload; and
the transmission pattern refers to a composition structure of the second channel or the third channel. For example, the channel may be divided into two parts: a 1^{st} part and a 2^{nd} part, and the 1^{st} part is used for determining information such as a transmission payload and an MCS of the 2^{nd} part. For example, transmission of information bits is fixed, and only the 1^{st} part may be needed in this case. If there are many content to be transmitted and different parts are needed to carry different information, the 1^{st} part may carry some content and indicate content of the 2^{nd} part. The transmission pattern may further indicate which common structures may be used in repeated transmission, such as a preamble and a terminator, which can be shared and only exist in a 1^{st} transmission and a last transmission.

In addition, for example, for guard band deployment, which occupies a small quantity of frequency domain resources and has a small operating bandwidth (or a power level of a receiving device is low and receiving performance is poor), the preamble is needed in this case for the PDCCH to ensure synchronization performance.

Optionally, when a size of a payload transmitted by the second channel or the third channel is fixed, at least a part of the modulation information of the second channel or the third channel includes information included in one of predetermined modulation information combinations.

Therefore, if the quantity of bits (namely, the payload size) transmitted by the second channel (namely, the PDSCH) or the third channel (namely, the PDCCH) is fixed, the modulation information of the second channel or the third channel may be several limited combinations. The modulation mode, the code rate, and the like that are used may be determined based on the time domain length of transmission and other indication information.

Optionally, when a size of a payload transmitted by the second channel or the third channel is variable, the size of the payload transmitted by the second channel or the third channel is determined by using one of the following manners:
determining the size of the payload transmitted by the second channel or the third channel based on a time domain length of transmission and a modulation and coding scheme index value;
determining the size of the payload transmitted by the second channel or the third channel from a variable payload candidate set including at least one payload value, where the variable payload candidate set is determined based on resource information or payload information of Internet of Things transmission; and
determining the size of the payload transmitted by the second channel or the third channel based on a specific preamble before the start of the payload and a specific terminator at the end of the payload.

Therefore, if the quantity of bits (namely, the payload size) transmitted by the second channel (namely, the PDSCH) or the third channel (namely, the PDCCH) is variable, a corresponding transport block size may be calculated based on a time domain length of transmission, a modulation and coding scheme (MCS) index value, and other content, and further demodulation is performed; or
the second device (for example, a network side device or a reader) may send resource information used for A-IoT transmission, so that the first device (for example, the A-IoT device) may determine a unique payload or a variable payload candidate set of A-IoT transmission based on indicated resource information of A-IoT transmission; or
the second device may send payload information of A-IoT transmission, so that the first device may determine a unique payload or a variable payload candidate set of A-IoT transmission based on indicated payload information; or
a specific preamble (which may include a delimiter) is sent before the start of the payload, and a specific terminator (ending-of-signaling) is sent at the end of the payload, to help the first device determine a start time and an end time of sending a signal by the second device, thereby determining the payload size.

An embodiment of this application provides an information indication method. As shown in FIG. 10, the method may include the following step 1001 to step 1002.

Step 1001: A second device sends a first channel.

The second device may be a network side device, such as a reader or a base station.

The first channel indicates target information of a second channel or a third channel, the first channel includes at least one of a synchronization channel (such as an LP-SSB) or a broadcast channel, and the target information includes at least one of frequency domain information, time domain information, or modulation information.

That is, the first channel indicates at least one of frequency domain information, time domain information, or modulation information of the second channel, or the first channel indicates at least one of frequency domain information, time domain information, or modulation information of the third channel.

In addition, the third channel indicates the second channel.

Optionally, the second channel includes a downlink shared channel, such as a physical downlink shared channel (PDSCH).

Optionally, the third channel includes a downlink control channel, such as a physical downlink control channel (PDCCH).

For example, at least one of the synchronization channel or the broadcast channel may indicate at least one of frequency domain information, time domain information, or modulation information of the PDCCH, or indicate at least one of frequency domain information, time domain information, or modulation information of the PDSCH.

In addition, system information may generally be divided into a master information block (MIB), system information block type 1 (SIB1), and other system information block types (other-SIB). The MIB may be carried by a low power synchronization signal block (LP-SSB), and SIB1 may be carried by a downlink shared channel (such as a PDSCH). That is, the system information carried by the second channel may include SIB1.

Step 1002: The second device sends the second channel based on the target information.

The second channel is used for carrying system information of Internet of Things communication; and the system information may include SIB1.

In this embodiment of this application, the first channel sent by the second device indicates at least one of frequency domain information, time domain information, or modulation information of the second channel, or the first channel indicates at least one of frequency domain information, time domain information, or modulation information of the third channel. Therefore, the second device may send the second channel based on at least one of frequency domain information, time domain information, or modulation information of the second channel; or send the third channel based on at least one of frequency domain information, time domain information, or modulation information of the third channel, thereby indicating the second channel by using the third channel. The second channel carries the system information of Internet of Things communication. Therefore, after receiving the second channel, the first device may obtain the system information of Internet of Things communication, to facilitate an initial access or other actions of the first device.

It can be learned from the above step 1001 to step 1002 that in this embodiment of this application, at least one of the synchronization channel or the broadcast channel may directly indicate the second channel carrying the system information of Internet of Things communication, or indirectly indicate the second channel carrying the system information of Internet of Things communication, so that the first device may obtain the system information of Internet of Things communication. Therefore, in this embodiment of this application, necessary system information required in an initial access of the Internet of Things device is provided, and the problem of how to establish an initial connection between an ambient Internet of Things device and a reader-writer device is solved.

Optionally, the sending, by the second device, the second channel based on the target information includes one of the following L-1 to L-3.

L-1: In a case that the first channel indicates the target information of the third channel, the second device sends the third channel based on the target information of the third channel indicated by the first channel, and sends the second channel based on the target information of the second channel indicated by the third channel.

It can be learned from L-1 that, the first channel may indirectly indicate the second channel, that is, the first channel may indicate the target information of the third channel, and the third channel may indicate the target information of the second channel; and that is, the first channel indicates at least one of frequency domain information, time domain information, or modulation information of the third channel, and the third channel indicates at least one of frequency domain information, time domain information, or modulation information of the second channel. For example, when the first channel is a synchronization or broadcast channel, the second channel is a PDSCH, and the third channel is a PDSCH, the synchronization or broadcast channel may indicate the PDCCH, and the PDCCH (for example, downlink control information (DCI) of the PDCCH) indicates the PDSCH.

In this case, after receiving the first channel, the first device may receive the third channel based on at least one of frequency domain information, time domain information, or modulation information that are of the third channel and that are indicated by the first channel, and further receive, after receiving the third channel, the second channel based on at least one of frequency domain information, time domain information, or modulation information that are of the second channel and that are indicated by the third channel, thereby obtaining the system information of Internet of Things communication from the received second channel, to facilitate an initial access or other actions of the first device.

L-2: The second device sends, in a case that the first channel indicates first information, the second channel based on the first information and second information indicated by header information of the second channel, where the first information includes a part of the target information of the second channel, and the second information includes information other than the first information in the target information of the second channel.

It can be learned from L-2 that, the first channel and the header information of the second channel may jointly indicate the second channel, that is, information of at least one of frequency domain information, time domain information, or modulation information of the second channel may be divided into two parts, that is, the first information and the second information, so that the first channel indicates the first information, and the header information of the second channel indicates the second information. For example, when the first channel is a synchronization or broadcast channel, and the second channel is a PDSCH, the synchronization or broadcast channel and the header information of the PDSCH may jointly indicate the PDSCH.

In this case, the first device may receive the second channel based on the first information indicated by the first channel and the second information indicated by the header information of the second channel, thereby obtaining the system information of Internet of Things communication from the received second channel, to facilitate an initial access or other actions of the first device.

The header information of the second channel belongs to a part of the second channel, that is, the header information of the second channel may indicate a part of the target information of the second channel (information such as a modulation and coding parameter, a payload size, and a time domain length of the second channel), and a payload part of the second channel is used for carrying the system information of Internet of Things communication (such as SIB1).

In addition, optionally, in a case that the first channel indicates the first information, and the header information of the second channel indicates the second information, the first channel further indicates the header information of the second channel. That is, the header information of the second channel may be indicated by the first channel.

L-3: The second device sends, in a case that the first channel indicates the target information of the second channel, the second channel based on the target information of the second channel indicated by the first channel.

It can be learned from L-3 that, the first channel may directly indicate the second channel, that is, the first channel may directly indicate at least one of frequency domain information, time domain information, or modulation information of the second channel. For example, when the first channel is a synchronization or broadcast channel, and the second channel is a PDSCH, the synchronization or broadcast channel may directly indicate the PDSCH.

In this case, after receiving the first channel, the first device may receive the second channel based on at least one of frequency domain information, time domain information, or modulation information that are of the second channel and that are indicated by the first channel, thereby obtaining the system information of Internet of Things communication from the received second channel, to facilitate an initial access or other actions of the first device.

Optionally, in a case that the target object indicates the third information, the following O-1 is satisfied.

O-1: The target object carries target indication information, and the target indication information indicates a value of the third information in a target table.

The target table is a table in a target correspondence that corresponds to at least one of a device type, a power level, a service type of the first device receiving the second channel, or a deployment mode of an ambient Internet of Things that the first device is to access, and the target correspondence includes a correspondence between the device type, the power level, the service type, the deployment mode of the ambient Internet of Things, and a table including the value of the third information;
in a case that the target object includes the first channel, the third information includes the target information of the third channel, or includes the first information;
in a case that the target object includes the third channel, the third information includes the target information of the second channel; and
in a case that the target object includes the header information of the second channel, the third information includes the second information.

For related description of O-1, refer to the foregoing description, and details are not described herein again.

Optionally, the target indication information satisfies at least one of the following C-1 to C-3.

C-1: At least a part of the target indication information is indicated by using a specific byte or a specific sequence of the target object.

C-2: At least a part of the target indication information is determined based on a length of CRC of the target object.

C-3: At least a part of the target indication information is determined based on a scrambling mode of CRC of the target object.

For related description of C-1 to C-3, refer to the foregoing description, and details are not described herein again.

Optionally, frequency domain information of at least one of the second channel or the third channel includes at least one of the following D-1 to D-4:
D-1: a frequency domain start point position;
D-2: a quantity of frequency bands occupied in frequency domain;
D-3: a bandwidth size of a signal; and D-4: a multiplexing mode with the first channel.

For related description of D-1 to D-4, refer to the foregoing description, and details are not described herein again.

Optionally, time domain information of at least one of the second channel or the third channel includes at least one of the following F-1 to F-4:
F-1: time domain position information;
F-2: a size of a monitoring window;
F-3: a monitoring cycle (the monitoring cycle may be related to a service of A-IoT, and monitoring cycles of the second channel and the third channel are also different); or
F-4: a time domain interleaving mode.

For related description of F-1 to F-4, refer to the foregoing description, and details are not described herein again.

Optionally, time domain position information of at least one of the second channel or the third channel includes at least one of the following:
a time domain position of a monitoring window of a channel to which the time domain position information belongs;
a start point of a monitoring cycle of a channel to which the time domain position information belongs; and
an offset of a monitoring window of a channel to which the time domain position information belongs relative to a start point of a monitoring cycle.

For related explanations of the above three items included in the time domain position information, refer to the foregoing description, and details are not described herein again.

Optionally, a size of a monitoring window of at least one of the second channel or the third channel is represented by using one of the following:
a time domain length occupied by a channel to which the monitoring window belongs;
a time domain length occupied by one transport block of the system information; and
a time domain length occupied by the header information of the second channel.

For related explanations of the above three items representing the size of the monitoring window, refer to the foregoing description, and details are not described herein again.

Optionally, modulation information of at least one of the second channel or the third channel includes at least one of the following G-1 to G-6:
G-1: a payload size (payload);
G-2: a modulation parameter;
G-3: a waveform parameter;
G-4: a quantity of time domain repetitions;
G-5: a time domain repetition mode; or
G-6: channel structure information.

For related description of G-1 to G-6, refer to the foregoing description, and details are not described herein again.

Optionally, the modulation parameter includes one of the following:
a parameter of linear coding; and
a parameter of channel coding.

Optionally, the waveform parameter includes at least one of the following modulation modes:
Gaussian filtered minimum shift keying (GMSK);
on-off keying (OOK);
amplitude shift keying (ASK);
frequency shift keying (FSK);
differential binary phase shift keying (DBPSK);
offset quadrature phase shift keying (OQPSK);
phase reverse amplitude shift keying (PR-ASK);
double sideband amplitude shift keying (DSB-ASK);
single sideband amplitude shift keying (SSB-ASK);
OOK-1;
OOK-2; or
OOK-4, where
OOK-1, OOK-2, and OOK-4 represent different multicarrier OOK signal generation modes based on an orthogonal frequency division multiplexing (OFDM) architecture.

In conclusion, a design of the system information SIB1 required by A-IoT communication is not considered in the existing related technologies. However, in the embodiments of this application, a design method for obtaining SIB1 related information from the synchronization channel or the broadcast channel by the A-IoT device is mainly given, specifically including an indication method and indication content of SIB1, and may be used in an initial access process of A-IoT communication.

The information indication method provided in this embodiment of this application may be executed by an information indication apparatus. In an embodiment of this application, the information indication apparatus provided in the embodiments of this application is described by using an example in which the information indication method is performed by an information indication apparatus.

An embodiment of this application provides an information indication apparatus, which may be applied to a first device (for example, an Internet of Things device). As shown in FIG. 11, the information indication apparatus 110 may include the following modules:
a first receiving module 1101, configured to receive a first channel, where the first channel indicates target information of a second channel or a third channel, the first channel includes at least one of a synchronization channel or a broadcast channel, and the target information includes at least one of frequency domain information, time domain information, or modulation information; and
a second receiving module 1102, configured to receive the second channel based on the target information, where the second channel is used for carrying system information of Internet of Things communication.

Optionally, the second receiving module 1102 is specifically configured to perform one of the following:
in a case that the first channel indicates the target information of the third channel, receiving the third channel by using the target information of the third channel, and receiving the second channel by using the target information of the second channel indicated by the third channel;
receiving, in a case that the first channel indicates first information, the second channel by using the first information and second information indicated by header information of the second channel, where the first information includes a part of the target information of the second channel, and the second information includes information other than the first information in the target information of the second channel; and
receiving, in a case that the first channel indicates the target information of the second channel, the second channel by using the target information of the second channel.

Optionally, in a case that the first channel indicates the first information, and the header information of the second channel indicates the second information, the first channel further indicates the header information of the second channel.

Optionally, in a case that a target object indicates third information, the target object carries target indication information, and the target indication information indicates a value of the third information in a target table;
the target table is a table in a target correspondence that corresponds to at least one of a device type, a power level, a service type of the first device, or a deployment mode of an ambient Internet of Things that the first device is to access, and the target correspondence includes a correspondence between the device type, the power level, the service type, the deployment mode of the ambient Internet of Things, and a table including the value of the third information;
in a case that the target object includes the first channel, the third information includes the target information of the third channel, or includes the first information;
in a case that the target object includes the third channel, the third information includes the target information of the second channel; and
in a case that the target object includes the header information of the second channel, the third information includes the second information.

Optionally, the target indication information satisfies at least one of the following:
at least a part of the target indication information is indicated by using a specific byte or a specific sequence of the target object;
at least a part of the target indication information is determined based on a length of CRC of the target object; or
at least a part of the target indication information is determined based on a scrambling mode of CRC of the target object.

Optionally, frequency domain information of at least one of the second channel or the third channel includes at least one of the following:
a frequency domain start point position;
a quantity of frequency bands occupied in frequency domain;
a bandwidth size of a signal; or
a multiplexing mode with the first channel.

Optionally, time domain information of at least one of the second channel or the third channel includes at least one of the following:
time domain position information;
a size of a monitoring window;
a monitoring cycle; or
a time domain interleaving mode.

Optionally, time domain position information of at least one of the second channel or the third channel includes at least one of the following:
a time domain position of a monitoring window of a channel to which the time domain position information belongs;
a start point of a monitoring cycle of a channel to which the time domain position information belongs; or
an offset of a monitoring window of a channel to which the time domain position information belongs relative to a start point of a monitoring cycle.

Optionally, a size of a monitoring window of at least one of the second channel or the third channel is represented by using one of the following:
a time domain length occupied by a channel to which the monitoring window belongs;
a time domain length occupied by one transport block of the system information; and
a time domain length occupied by the header information of the second channel.

Optionally, modulation information of at least one of the second channel or the third channel includes at least one of the following:
a payload size;
a modulation parameter;
a waveform parameter;
a quantity of time domain repetitions;
a time domain repetition mode; or
channel structure information.

Optionally, the modulation parameter includes one of the following:
a parameter of linear coding; and
a parameter of channel coding.

Optionally, the waveform parameter includes at least one of the following modulation modes:
Gaussian filtered minimum shift keying (GMSK);
on-off keying (OOK);
amplitude shift keying (ASK);
frequency shift keying (FSK);
differential binary phase shift keying (DBPSK);
offset quadrature phase shift keying (OQPSK);
phase reverse amplitude shift keying (PR-ASK);
double sideband amplitude shift keying (DSB-ASK);
single sideband amplitude shift keying (SSB-ASK);
OOK-1;
OOK-2; or
OOK-4, where
OOK-1, OOK-2, and OOK-4 represent different multicarrier OOK signal generation modes based on an orthogonal frequency division multiplexing (OFDM) architecture.

Optionally, the second channel includes a physical downlink shared channel.

Optionally, the third channel includes a downlink control channel.

The information indication apparatus in this embodiment of this application may be an electronic device, for example, an electronic device with an operating system, or may be a component in the electronic device, for example, an integrated circuit or a chip. The electronic device may be a terminal. For example, the terminal may include but is not limited to the foregoing listed types of the terminal 11. This is not specifically limited in this embodiment of this application.

The information indication apparatus provided in this embodiment of this application can implement the processes implemented in the method embodiments from FIG. 7 to FIG. 9, and achieve a same technical effect. To avoid repetition, details are not described herein again.

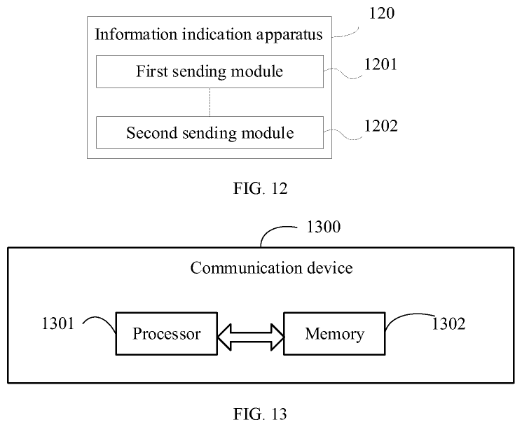

An embodiment of this application provides an information indication apparatus, which may be applied to a second device (for example, a network side device). As shown in FIG. 12, the information indication apparatus 120 may include the following modules:
a first sending module 1201, configured to send a first channel, where the first channel indicates target information of a second channel or a third channel, the first channel includes at least one of a synchronization channel or a broadcast channel, and the target information includes at least one of frequency domain information, time domain information, or modulation information; and
a second sending module 1202, configured to send the second channel based on the target information, where the second channel is used for carrying system information of Internet of Things communication.

Optionally, the second sending module 1202 is specifically configured to perform one of the following:
in a case that the first channel indicates the target information of the third channel, sending the third channel based on the target information of the third channel indicated by the first channel, and sending the second channel based on the target information of the second channel indicated by the third channel;
sending, in a case that the first channel indicates first information, the second channel based on the first information and second information indicated by header information of the second channel, where the first information includes a part of the target information of the second channel, and the second information includes information other than the first information in the target information of the second channel; and
sending, in a case that the first channel indicates the target information of the second channel, the second channel based on the target information of the second channel indicated by the first channel.

Optionally, in a case that the first channel indicates the first information, and the header information of the second channel indicates the second information, the first channel further indicates the header information of the second channel.

Optionally, in a case that a target object indicates third information, the target object carries target indication information, and the target indication information indicates a value of the third information in a target table;
the target table is a table in a target correspondence that corresponds to at least one of a device type, a power level, a service type of the first device receiving the second channel, or a deployment mode of an ambient Internet of Things that the first device is to access, and the target correspondence includes a correspondence between the device type, the power level, the service type, the deployment mode of the ambient Internet of Things, and a table including the value of the third information;
in a case that the target object includes the first channel, the third information includes the target information of the third channel, or includes the first information;
in a case that the target object includes the third channel, the third information includes the target information of the second channel; and
in a case that the target object includes the header information of the second channel, the third information includes the second information.

Optionally, the target indication information satisfies at least one of the following: at least a part of the target indication information is indicated by using a specific byte or a specific sequence of the target object;
at least a part of the target indication information is determined based on a length of CRC of the target object; or
at least a part of the target indication information is determined based on a scrambling mode of CRC of the target object.

Optionally, frequency domain information of at least one of the second channel or the third channel includes at least one of the following:
a frequency domain start point position;
a quantity of frequency bands occupied in frequency domain;
a bandwidth size of a signal; or
a multiplexing mode with the first channel.

Optionally, time domain information of at least one of the second channel and the third channel includes at least one of the following:
time domain position information;
a size of a monitoring window;
a monitoring cycle; or
a time domain interleaving mode.

Optionally, time domain position information of at least one of the second channel or the third channel includes at least one of the following:
a time domain position of a monitoring window of a channel to which the time domain position information belongs;
a start point of a monitoring cycle of a channel to which the time domain position information belongs; or
an offset of a monitoring window of a channel to which the time domain position information belongs relative to a start point of a monitoring cycle.

Optionally, a size of a monitoring window of at least one of the second channel or the third channel is represented by using one of the following:
a time domain length occupied by a channel to which the monitoring window belongs;
a time domain length occupied by one transport block of the system information; and
a time domain length occupied by the header information of the second channel.

Optionally, modulation information of at least one of the second channel or the third channel includes at least one of the following:
a payload size;
a modulation parameter;
a waveform parameter;
a quantity of time domain repetitions;
a time domain repetition mode; or
channel structure information.

Optionally, the modulation parameter includes one of the following:
a parameter of linear coding; and
a parameter of channel coding.

Optionally, the waveform parameter includes at least one of the following modulation modes:
Gaussian filtered minimum shift keying (GMSK);
on-off keying (OOK);
amplitude shift keying (ASK);
frequency shift keying (FSK);
differential binary phase shift keying (DBPSK);
offset quadrature phase shift keying (OQPSK);
phase reverse amplitude shift keying (PR-ASK);
double sideband amplitude shift keying (DSB-ASK);
single sideband amplitude shift keying (SSB-ASK);
OOK-1;
OOK-2; or
OOK-4, where
OOK-1, OOK-2, and OOK-4 represent different multicarrier OOK signal generation modes based on an orthogonal frequency division multiplexing (OFDM) architecture.

Optionally, the second channel includes a physical downlink shared channel.

Optionally, the third channel includes a downlink control channel.

The information indication apparatus in this embodiment of this application may be an electronic device, for example, an electronic device with an operating system, or may be a component in the electronic device, for example, an integrated circuit or a chip. The electronic device may be a network side device. For example, the network side device may include but is not limited to the types of network side devices 12 listed above. This is not specifically limited in this embodiment of this application.

The information indication apparatus provided in this embodiment of this application can implement the processes implemented in the method embodiment of FIG. 10, and achieve a same technical effect. To avoid repetition, details are not described herein again.

As shown in FIG. 13, an embodiment of this application further provides a communication device 1300, including a processor 1301 and a memory 1302. The memory 1302 stores a program or an instruction that can be run on the processor 1301. For example, when the communication device 1300 is a first device, the program or the instruction is executed by the processor 1301 to implement the steps of the information indication method embodiment applied to the first device, and a same technical effect can be achieved. When the communication device 1300 is a second device, the program or the instruction is executed by the processor 1301 to implement the steps of the information indication method embodiment applied to the second device, and a same technical effect can be achieved. To avoid repetition, details are not described herein again.

An embodiment of this application further provides a terminal, including a processor and a communication interface. The communication interface is coupled to the processor, and the processor is configured to run a program or an instruction to implement the steps of the method embodiment shown in FIG. 7. The terminal embodiment is corresponding to the method embodiment on the terminal side, each implementation process and implementation of the method embodiment can be applied to the terminal embodiment, and a same technical effect can be achieved. Specifically, FIG. 14 is a schematic diagram of a hardware structure of a terminal according to an embodiment of this application.

The terminal 1400 includes but is not limited to at least a part of components such as a radio frequency unit 1401, a network module 1402, an audio output unit 1403, an input unit 1404, a sensor 1405, a display unit 1406, a user input unit 1407, an interface unit 1408, a memory 1409, and a processor 1410.

It may be understood by a person skilled in the art that the terminal 1400 may further include a power supply (such as a battery) that supplies power to each component. The power supply may be logically connected to the processor 1410 by using a power management system, to implement functions such as charging, discharging, and power consumption management by using the power management system. The terminal structure shown in FIG. 14 constitutes no limitation on the terminal, and the terminal may include more or fewer components than those shown in the figure, or combine some components, or have different component arrangements. Details are not described herein.

It should be understood that in this embodiment of this application, the input unit 1404 may include a graphics processing unit (GPU) 14041 and a microphone 14042. The graphics processing unit 14041 processes image data of a static picture or a video obtained by an image capture apparatus (for example, a camera) in a video capture mode or an image capture mode. The display unit 1406 may include a display panel 14061, and the display panel 14061 may be configured in a form of a liquid crystal display, an organic light-emitting diode, or the like. The user input unit 1407 includes at least one of a touch panel 14071 or another input device 14072. The touch panel 14071 is also referred to as a touchscreen. The touch panel 14071 may include two parts: a touch detection apparatus and a touch controller. The another input device 14072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1401 may transmit the downlink data to the processor 1410 for processing. In addition, the radio frequency unit 1401 may send uplink data to the network side device. Generally, the radio frequency unit 1401 includes but is not limited to an antenna, an amplifier, a transceiver, a coupler, a low noise amplifier, a duplexer, and the like.

The memory 1409 may be configured to store a software program or an instruction and various data. The memory 1409 may mainly include a first storage area for storing a program or an instruction and a second storage area for storing data. The first storage area may store an operating system, and an application or an instruction required by at least one function (for example, a sound playing function or an image playing function). In addition, the memory 1409 may include a volatile memory or a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1409 in this embodiment of this application includes but is not limited to these memories and any memory of another proper type.

The processor 1410 may include one or more processing units. Optionally, an application processor and a modem processor are integrated into the processor 1410. The application processor mainly processes an operating system, a user interface, an application, or the like. The modem processor mainly processes a wireless communication signal, for example, a baseband processor. It may be understood that, alternatively, the modem processor may not be integrated into the processor 1410.

The radio frequency unit 1401 is configured to:
receive a first channel, where the first channel indicates target information of a second channel or a third channel, the first channel includes at least one of a synchronization channel or a broadcast channel, and the target information includes at least one of frequency domain information, time domain information, or modulation information; and
receive the second channel based on the target information, where the second channel is used for carrying system information of Internet of Things communication.

Optionally, that the radio frequency unit 1401 receives the second channel based on the target information includes one of the following:
in a case that the first channel indicates the target information of the third channel, receiving the third channel by using the target information of the third channel, and receiving the second channel by using the target information of the second channel indicated by the third channel;
receiving, in a case that the first channel indicates first information, the second channel by using the first information and second information indicated by header information of the second channel, where the first information includes a part of the target information of the second channel, and the second information includes information other than the first information in the target information of the second channel; and
receiving, in a case that the first channel indicates the target information of the second channel, the second channel by using the target information of the second channel.

Optionally, in a case that the first channel indicates the first information, and the header information of the second channel indicates the second information, the first channel further indicates the header information of the second channel.

Optionally, in a case that a target object indicates third information, the target object carries target indication information, and the target indication information indicates a value of the third information in a target table;
the target table is a table in a target correspondence that corresponds to at least one of a device type, a power level, a service type of the first device, or a deployment mode of an ambient Internet of Things that the first device is to access, and the target correspondence includes a correspondence between the device type, the power level, the service type, the deployment mode of the ambient Internet of Things, and a table including the value of the third information;
in a case that the target object includes the first channel, the third information includes the target information of the third channel, or includes the first information;
in a case that the target object includes the third channel, the third information includes the target information of the second channel; and
in a case that the target object includes the header information of the second channel, the third information includes the second information.

Optionally, the target indication information satisfies at least one of the following:
at least a part of the target indication information is indicated by using a specific byte or a specific sequence of the target object;
at least a part of the target indication information is determined based on a length of CRC of the target object; or
at least a part of the target indication information is determined based on a scrambling mode of CRC of the target object.

Optionally, frequency domain information of at least one of the second channel or the third channel includes at least one of the following:
a frequency domain start point position;
a quantity of frequency bands occupied in frequency domain;
a bandwidth size of a signal; or
a multiplexing mode with the first channel.

Optionally, time domain information of at least one of the second channel or the third channel includes at least one of the following:
time domain position information;
a size of a monitoring window;
a monitoring cycle; or
a time domain interleaving mode.

Optionally, time domain position information of at least one of the second channel and the third channel includes at least one of the following:
a time domain position of a monitoring window of a channel to which the time domain position information belongs;
a start point of a monitoring cycle of a channel to which the time domain position information belongs; or
an offset of a monitoring window of a channel to which the time domain position information belongs relative to a start point of a monitoring cycle.

Optionally, a size of a monitoring window of at least one of the second channel or the third channel is represented by using one of the following:
a time domain length occupied by a channel to which the monitoring window belongs;
a time domain length occupied by one transport block of the system information; and
a time domain length occupied by the header information of the second channel.

Optionally, modulation information of at least one of the second channel or the third channel includes at least one of the following:
a payload size;
a modulation parameter;
a waveform parameter;
a quantity of time domain repetitions;
a time domain repetition mode; or
channel structure information.

Optionally, the modulation parameter includes one of the following:
a parameter of linear coding; and
a parameter of channel coding.

Optionally, the waveform parameter includes at least one of the following modulation modes:
Gaussian filtered minimum shift keying (GMSK);
on-off keying (OOK);
amplitude shift keying (ASK);
frequency shift keying (FSK);
differential binary phase shift keying (DBPSK);
offset quadrature phase shift keying (OQPSK);
phase reverse amplitude shift keying (PR-ASK);
double sideband amplitude shift keying (DSB-ASK);
single sideband amplitude shift keying (SSB-ASK);
OOK-1;
OOK-2; or
OOK-4, where
OOK-1, OOK-2, and OOK-4 represent different multicarrier OOK signal generation modes based on an orthogonal frequency division multiplexing (OFDM) architecture.

Optionally, the second channel includes a physical downlink shared channel.

Optionally, the third channel includes a downlink control channel.

It can be understood that for the implementation process of each implementation given in this embodiment, refer to the related description of the information indication method embodiment applied to the first device, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 10. This network side device embodiment is corresponding to the foregoing method embodiment of the network side device. Each implementation process and implementation of the foregoing method embodiment may be applicable to this network side device embodiment, and a same technical effect can be achieved.

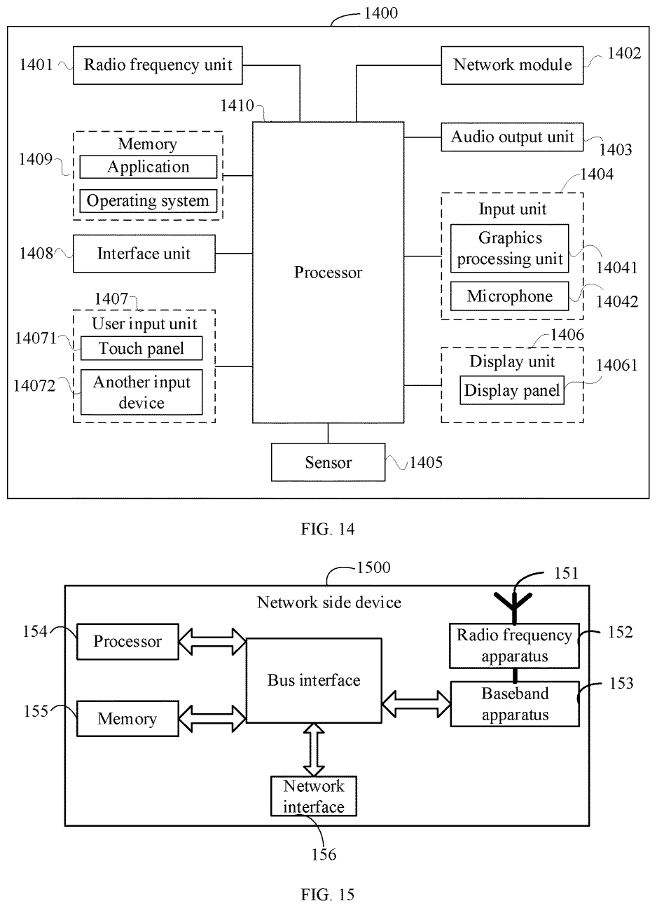

Specifically, an embodiment of this application further provides a network side device. As shown in FIG. 15, the network side device 1500 includes an antenna 151, a radio frequency apparatus 152, a baseband apparatus 153, a processor 154, and a memory 155. The antenna 151 is connected to the radio frequency apparatus 152. In an uplink direction, the radio frequency apparatus 152 receives information through the antenna 151, and sends the received information to the baseband apparatus 153 for processing. In a downlink direction, the baseband apparatus 153 processes information that needs to be sent, and sends processed information to the radio frequency apparatus 152. The radio frequency apparatus 152 processes the received information, and sends processed information through the antenna 151.

In the foregoing embodiment, the method performed by the network side device may be implemented in the baseband apparatus 153. The baseband apparatus 153 includes a baseband processor.

For example, the baseband apparatus 153 may include at least one baseband board. A plurality of chips are disposed on the baseband board. As shown in FIG. 15, one chip is, for example, a baseband processor, and is connected to the memory 155 by using a bus interface, to invoke a program in the memory 155 to perform the operations of the network device shown in the foregoing method embodiment.

The network side device may further include a network interface 156, and the interface is, for example, a common public radio interface (CPRI).

Specifically, the network side device 1500 in this embodiment of the present invention further includes an instruction or a program that is stored in the memory 155 and that can be run on the processor 154. The processor 154 invokes the instruction or the program in the memory 155 to perform the method performed by the modules shown in FIG. 12, and a same technical effect is achieved. To avoid repetition, details are not described herein again.

An embodiment of this application further provides a readable storage medium. The readable storage medium stores a program or an instruction, and when the program or the instruction is executed by a processor, the processes of the information indication method embodiment are performed, with a same technical effect achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the information indication method embodiment, with a same technical effect achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the information indication method embodiment, with a same technical effect achieved. To avoid repetition, details are not described herein again.

An embodiment of this application further provides an information indication system, including a first device and a second device. The first device may be configured to perform the steps of the information indication method applied to the first device, and the second device may be configured to perform the steps of the information indication method applied to the second device.

In the embodiments of this application, a first device may receive a first channel, where the first channel indicates target information of a second channel or a third channel, the first channel includes at least one of a synchronization channel or a broadcast channel, and the target information includes at least one of frequency domain information, time domain information, or modulation information, to receive the second channel based on the target information, where the second channel is used for carrying system information of Internet of Things communication.

It can be learned that in the embodiments of this application, the target information of the second channel or the target information of the third channel may be indicated by at least one of the synchronization channel or the broadcast channel, so that after receiving the first channel, the first device may receive, based on the target information of the second channel, the second channel carrying the system information of Internet of Things communication; or receive the third channel based on the target information of the third channel, and further receive, based on the indication of the third channel, the second channel carrying the system information of Internet of Things communication. That is, in the embodiments of this application, at least one of the synchronization channel or the broadcast channel may directly indicate the second channel carrying the system information of Internet of Things communication, or indirectly indicate the second channel carrying the system information of Internet of Things communication, so that the first device may obtain the system information of Internet of Things communication. Therefore, in the embodiments of this application, necessary system information required in an initial access of the Internet of Things device is provided, and the problem of how to establish an initial connection between an ambient Internet of Things device and a reader-writer device is solved.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. An information indication method, wherein the method comprises:
receiving, by a first device, a first channel, wherein the first channel indicates target information of a second channel or a third channel, the first channel comprises at least one of a synchronization channel or a broadcast channel, and the target information comprises at least one of frequency domain information, time domain information, or modulation information; and
receiving, by the first device, the second channel based on the target information, wherein the second channel is used for carrying system information of Internet of Things communication.

2. The method according to claim 1, wherein the receiving, by the first device, the second channel based on the target information comprises one of the following:
in a case that the first channel indicates the target information of the third channel, receiving, by the first device, the third channel by using the target information of the third channel, and receiving the second channel by using the target information of the second channel indicated by the third channel;
receiving, by the first device in a case that the first channel indicates first information, the second channel by using the first information and second information indicated by header information of the second channel, wherein the first information comprises a part of the target information of the second channel, and the second information comprises information other than the first information in the target information of the second channel; and
receiving, by the first device in a case that the first channel indicates the target information of the second channel, the second channel by using the target information of the second channel.

3. The method according to claim 2, wherein in a case that the first channel indicates the first information, and the header information of the second channel indicates the second information, the first channel further indicates the header information of the second channel.

4. The method according to claim 2, wherein in a case that a target object indicates third information, the target object carries target indication information, and the target indication information indicates a value of the third information in a target table;
the target table is a table in a target correspondence that corresponds to at least one of a device type, a power level, a service type of the first device, or a deployment mode of an ambient Internet of Things that the first device is to access, and the target correspondence comprises a correspondence between the device type, the power level, the service type, the deployment mode of the ambient Internet of Things, and a table comprising the value of the third information;
in a case that the target object comprises the first channel, the third information comprises the target information of the third channel, or comprises the first information;
in a case that the target object comprises the third channel, the third information comprises the target information of the second channel; and
in a case that the target object comprises the header information of the second channel, the third information comprises the second information.

5. The method according to claim 4, wherein the target indication information satisfies at least one of the following:
at least a part of the target indication information is indicated by using a specific byte or a specific sequence of the target object;
at least a part of the target indication information is determined based on a length of CRC of the target object; or
at least a part of the target indication information is determined based on a scrambling mode of CRC of the target object.

6. The method according to claim 1, wherein frequency domain information of at least one of the second channel or the third channel comprises at least one of the following:
a frequency domain start point position;
a quantity of frequency bands occupied in frequency domain;
a bandwidth size of a signal; or
a multiplexing mode with the first channel.

7. The method according to claim 1, wherein time domain information of at least one of the second channel or the third channel comprises at least one of the following:
time domain position information;
a size of a monitoring window;
a monitoring cycle; or
a time domain interleaving mode.

8. The method according to claim 7, wherein time domain position information of at least one of the second channel or the third channel comprises at least one of the following:
a time domain position of a monitoring window of a channel to which the time domain position information belongs;
a start point of a monitoring cycle of a channel to which the time domain position information belongs; or
an offset of a monitoring window of a channel to which the time domain position information belongs relative to a start point of a monitoring cycle.

9. The method according to claim 7, wherein a size of a monitoring window of at least one of the second channel or the third channel is represented by using one of the following:
a time domain length occupied by a channel to which the monitoring window belongs;
a time domain length occupied by one transport block of the system information; and
a time domain length occupied by the header information of the second channel.

10. The method according to claim 1, wherein modulation information of at least one of the second channel or the third channel comprises at least one of the following:
a payload size;
a modulation parameter;
a waveform parameter;
a quantity of time domain repetitions;
a time domain repetition mode; or
channel structure information.

11. The method according to claim 10, wherein the modulation parameter comprises one of the following:
a parameter of linear coding; and
a parameter of channel coding; and
the waveform parameter comprises at least one of the following modulation modes:
Gaussian filtered minimum shift keying (GMSK);
on-off keying (OOK);
amplitude shift keying (ASK);
frequency shift keying (FSK);
differential binary phase shift keying (DBPSK);
offset quadrature phase shift keying (OQPSK);
phase reverse amplitude shift keying (PR-ASK);
double sideband amplitude shift keying (DSB-ASK);
single sideband amplitude shift keying (SSB-ASK);
OOK-1;
OOK-2; or
OOK-4, wherein
OOK-1, OOK-2, and OOK-4 represent different multicarrier OOK signal generation modes based on an orthogonal frequency division multiplexing (OFDM) architecture.

12. The method according to claim 1, wherein the second channel comprises a downlink shared channel; and
the third channel comprises a downlink control channel.

13. An information indication method, comprising:
sending, by a second device, a first channel, wherein the first channel indicates target information of a second channel or a third channel, the first channel comprises at least one of a synchronization channel or a broadcast channel, and the target information comprises at least one of frequency domain information, time domain information, or modulation information; and
sending, by the second device, the second channel based on the target information, wherein the second channel is used for carrying system information of Internet of Things communication.

14. The method according to claim 13, wherein the sending, by the second device, the second channel based on the target information comprises one of the following:
in a case that the first channel indicates the target information of the third channel, sending, by the second device, the third channel based on the target information of the third channel indicated by the first channel, and sending the second channel based on the target information of the second channel indicated by the third channel;
sending, by the second device in a case that the first channel indicates first information, the second channel based on the first information and second information indicated by header information of the second channel, wherein the first information comprises a part of the target information of the second channel, and the second information comprises information other than the first information in the target information of the second channel; and
sending, by the second device in a case that the first channel indicates the target information of the second channel, the second channel based on the target information of the second channel indicated by the first channel.

15. The method according to claim 14, wherein in a case that the first channel indicates the first information, and the header information of the second channel indicates the second information, the first channel further indicates the header information of the second channel.

16. The method according to claim 14, wherein in a case that a target object indicates third information, the target object carries target indication information, and the target indication information indicates a value of the third information in a target table;
the target table is a table in a target correspondence that corresponds to at least one of a device type, a power level, a service type of the first device receiving the second channel, or a deployment mode of an ambient Internet of Things that the first device is to access, and the target correspondence comprises a correspondence between the device type, the power level, the service type, the deployment mode of the ambient Internet of Things, and a table comprising the value of the third information;
in a case that the target object comprises the first channel, the third information comprises the target information of the third channel, or comprises the first information;
in a case that the target object comprises the third channel, the third information comprises the target information of the second channel; and
in a case that the target object comprises the header information of the second channel, the third information comprises the second information.

17. The method according to claim 13, wherein frequency domain information of at least one of the second channel or the third channel comprises at least one of the following:
a frequency domain start point position;
a quantity of frequency bands occupied in frequency domain;
a bandwidth size of a signal; or
a multiplexing mode with the first channel.

18. The method according to claim 13, wherein time domain information of at least one of the second channel or the third channel comprises at least one of the following:
time domain position information;
a size of a monitoring window;
a monitoring cycle; or
a time domain interleaving mode.

19. A communication device, comprising:
a processor implemented in hardware and a memory, wherein the memory stores a program or an instruction executable by the processor, and the program or the instruction, when executed, directs the processor to implement:
receiving a first channel, wherein the first channel indicates target information of a second channel or a third channel, the first channel comprises at least one of a synchronization channel or a broadcast channel, and the target information comprises at least one of frequency domain information, time domain information, or modulation information; and
receiving the second channel based on the target information, wherein the second channel is used for carrying system information of Internet of Things communication.

20. A communication device, comprising a processor implemented in hardware and a memory, wherein the memory stores a program or an instruction that executable the processor, and the program or the instruction, when executed, directs the processor to implement the information indication method according to claim 13.
